(19) United States
(12) Patent Application Publication
(10) Pub. No.: US 2021/0039605 A1
(43) Pub. Date: Feb. 11, 2021

(54) VIBRATING VEHICLE WINDSHIELD WIPERS WITH HEATING ELEMENT

(71) Applicant: Saad Alsabti, Sterling Heights, MI (US)

(72) Inventor: Saad Alsabti, Sterling Heights, MI (US)

(21) Appl. No.: 16/945,252

(22) Filed: Jul. 31, 2020

Related U.S. Application Data
(60) Provisional application No. 62/884,138, filed on Aug. 7, 2019.

(51) Int. Cl. B60S 1/38; B60S 1/04; B60S 1/08; B60S 1/28; B60S 1/02; B60S 1/34

(52) U.S. Cl. CPC B60S 1/3805; B60S 1/048; B60S 1/3463; B60S 1/28; B60S 1/026; B60S 1/08

(57) ABSTRACT

The vibrating vehicle windshield wipers with heating element for private and commercial vehicles effectively clear away snow, ice, and other inclement weather debris from both the vehicle windshield and the wipers themselves. The vibration and heating element ensure the windshield wipers remain functional at all times, eliminating the need to apply manual brushes and scrapers to a windshield and utilizes sensors to either manually or automatically trigger the heating element, controlled via the internal defrosting mechanism in the vehicle.

### CROSS-REFERENCE TO RELATED APPLICATION

The present application is related to and claims priority from prior provisional application Ser. No. 62/884,138, filed Aug. 7, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of vehicle windshield wipers. More specifically, the invention is a vibrating vehicle windshield wiper with heating element to better remove snow, rain, and other inclement weather debris from the windshield of vehicles.

### 2. Description of the Related Art

Driving during wintry weather can be problematic, difficult, and frustrating. Snow and ice can accumulate on the windshield wipers and be difficult to clean off. Drivers may be forced to stop their vehicle and use manual brushes and scrapers to clear the windshield due to the wipers being unable to effectively remove debris. Standard windshield wipers may get frozen and vehicle owners will have to wait to drive until the wipers are defrosted.

Ideally, a vibrating vehicle windshield wiper with heating element should provide a pair of heated windshield wipers that vibrate to better remove snow and other inclement weather debris and, yet would operate reliably and be manufactured at a modest expense. Thus, a need exists for a reliable a heated vibrating vehicle windshield wiper to avoid the above-mentioned problems.

### BRIEF SUMMARY OF THE INVENTION

In view of the foregoing disadvantages inherent in the known vehicle windshield wiper art, the present invention provides a novel vibrating vehicle windshield wiper with defrosting system. The general purpose of the present invention, which will be described subsequently in greater detail is to provide private and commercial vehicles with modified windshield wipers used to effectively clear away snow, ice, and other inclement weather debris from both the vehicle windshield and the wipers themselves. It should be noted that the vibrating vehicle windshield wiper with defrosting system mat also be suitably used on devices such as but not limited to airplanes, trains, ships and sailing boats.

The presently claimed invention ensures the windshield wipers remain functional at all times, eliminating the need to apply manual brushes and scrapers to a windshield and utilizes sensors to automatically trigger the heating element, controllable via the internal defrosting mechanism in the vehicle.

The presently claimed invention holds significant improvements and serves as vibrating vehicle windshield wipers with a heating system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a vibrating vehicle windshield wiper with defrosting mechanism, constructed and operative according to the teachings of the present invention.

FIG. 1 shows a perspective view illustrating the vibration mechanism on the windshield wipers, according to an embodiment of the presently claimed invention.

FIG. 2 is a close-up view illustrating the temperature sensor on the windshield wipers, according to an embodiment of the presently claimed invention.

FIG. 3 is a perspective view illustrating a vehicle with the vibrating windshield wiper with heating element installed, according to an embodiment of the presently claimed invention.

The various embodiments of the present invention will hereinafter be described in conjunction with the appended drawings, wherein like designations denote like elements.

### DETAILED DESCRIPTION

As discussed above, embodiments of the presently claimed invention relate to a vibrating vehicle windshield wiper with a defrosting system and more particularly to a vehicle windshield wiper that uses vibration and a defrosting system to keep both the vehicle windshield and the windshield wipers themselves free from snow, ice, and other inclement weather debris, improving visibility and thus safety while driving in inclement weather.

Generally speaking, the wipers can be fitted onto any make or model of vehicle. Users are able to remove all debris while the vehicle is in operation, improving roadway safety during inclement weather. As stated previously, the vibrating vehicle windshield wiper with defrosting system may also be suitably used on devices such as but not limited to airplanes, trains, ships and sailing boats

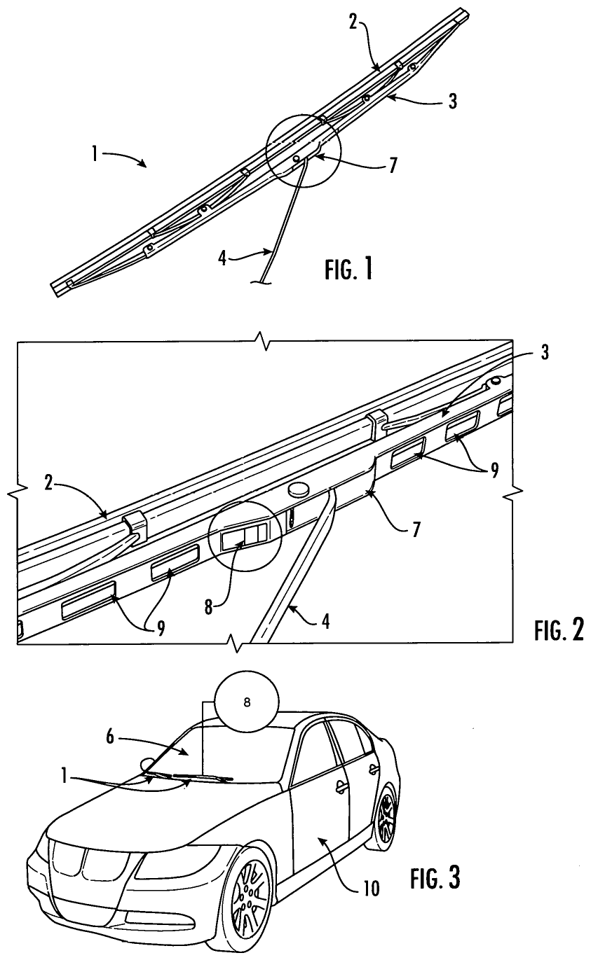

Referring to the drawings by numerals of reference there is shown in FIG. 1, a vibrating vehicle windshield wiper with heating element 1. The windshield wiper 1 has a wiper blade 2 that attaches to a blade support 3. The wiper blade 2 is a flexible blade, preferably made from a rubber or plastic material, that glides over the surface of the windshield 6, removing the rain, snow, dirt, ice, etc. The blade support 3 runs the full length of the wiper blade 2 and is preferably made of a sturdy material such as metal or a metal alloy. The blade support 3 connects to the wiper arm 4. The wiper arm 4 connects to the wiper motor(s) 5 on the vehicle. The wiper motor(s) 5 proper the wiper blades 2 back and forth across the vehicle's windshield 6, via the wiper arm 4 and the blade support 3.

The windshield wiper 1 has a vibration motor 7 at the connection between the blade support 3 and the wiper arm 4. The vibration motor 7 causes the blade support 3 to vibrate, thereby vibrating the wiper blade 2. By vibrating the blade support 3 and wiper blade 2, the windshield wiper 1 shakes debris free from the wiper blades 2 for convenient removal.

Referring now to FIG. 2, the vibrating windshield wiper 1 has a temperature sensor 8 connecting to one or more heating element(s) 9 that runs along the length of the blade support 3. The heating element(s) 9 defrost the wipers blade 2 and blade support 3. The vibrating motor 7 and heating element(s) 9 are controlled by a user from inside the vehicle in the same manner the wiper motor(s) 5 are controlled. Alternately, the temperature sensor 8 may automatically activate the heating element(s) 9 when the temperature reaches a pre-set threshold.

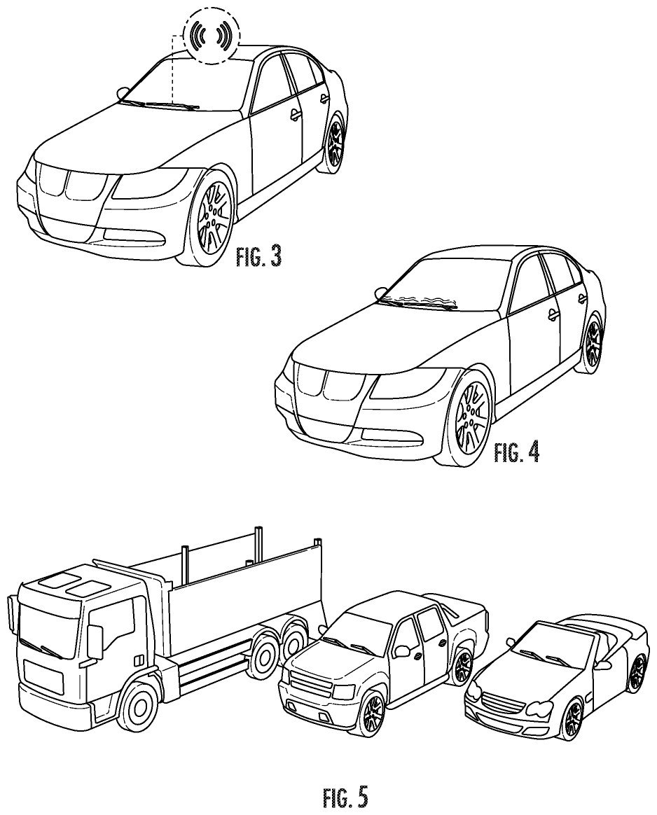

Referring now to FIG. 3, the vibrating windshield wipers with heating element 1 can be installed on any type of vehicle 10. As the vibrating motor 7, temperature sensor 8, and heating element(s) 9 are on or within the blade support 3, vehicle owners can interchange the wiper blades 2 with ease without removing the vibration 7 and temperature sensor 8 mechanisms.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by letters patent is set forth in the appended claims:

1. A vibrating and heating vehicle windshield wiper comprising:
a. a wiper blade;
b. a blade support with a length, wherein the wiper blade is removably connected to the blade support along the length of the blade support so that the blade support holds the wiper blade against a windshield of a vehicle;
c. a wiper arm, wherein the wiper arm is operably connected to the blade support so that the blade support is propellable back and forth across the windshield by the wiper arm;
d. a vibrating motor, wherein the vibrating motor is operably connected between the blade support and the wiper arm to vibrate the blade support with respect to the wiper arm; and
e. one or more heating elements, wherein the one or more heating elements are operably connected along the length of the blade support to heat the blade support when activated.

2. The vibrating and heating vehicle windshield wiper according to claim 1, further comprising:
f. a temperature sensor, wherein the temperature sensor is operably connected to the one or more heating elements to activate the one or more heating elements when a pre-set temperature is detected.

3. The vibrating and heating vehicle windshield wiper according to claim 1, wherein the wiper blade comprises a flexible rubber material or a flexible plastic material.

4. The vibrating and heating vehicle windshield wiper according to claim 1, wherein the vibrating motor and the one or more heating elements are operably connected to a programmable device of the vehicle so the vibrating motor and the one or more heating elements are manually controllable by a driver from inside the vehicle.

5. A vibrating and heating vehicle windshield wiper system comprising:
a. a first vibrating and heating vehicle windshield wiper according to claim 1; and
b. a second vibrating and heating vehicle windshield wiper according to claim 1.

6. A vibrating and heating vehicle windshield wiper comprising:
a. a wiper blade, wherein the wiper blade comprises a flexible rubber material or a flexible plastic material;
b. a blade support with a length, wherein the wiper blade is removably connected to the blade support along the length of the blade support so that the blade support holds the wiper blade against a windshield of a vehicle;
c. a wiper arm, wherein the wiper arm is operably connected to the blade support so that the blade support is propellable back and forth across the windshield by the wiper arm;
d. a vibrating motor, wherein the vibrating motor is operably connected between the blade support and the wiper arm to vibrate the blade support with respect to the wiper arm;
e. one or more heating elements, wherein the one or more heating elements are operably connected along the length of the blade support to heat the blade support when activated; and
f. a temperature sensor, wherein the temperature sensor is operably connected to the one or more heating elements to activate the one or more heating elements when a pre-set temperature is detected,
wherein the vibrating motor and the one or more heating elements are operably connected to a programmable device of the vehicle so the vibrating motor and the one or more heating elements are additionally manually controllable by a driver from inside the vehicle.

7. The vibrating and heating vehicle windshield wiper system of claim 6 further comprising:
a. a first vibrating and heating vehicle windshield wiper according to claim 6; and
b. a second vibrating and heating vehicle windshield wiper according to claim 6.
